(19) United States
(12) Patent Application Publication
(10) Pub. No.: US 2004/0208599 A1
(43) Pub. Date: Oct. 21, 2004

(54) Communications system

(76) Inventors: Jerome Swartz, Old Field, NY (US); Joseph Katz, Stony Brook, NY (US); Miklos Stern, Flushing, NY (US)

Correspondence Address: MITCHELL S. FELLER, HOGAN & HARTSON, LLP, 875 THIRD AVENUE, NEWYORK, NY, 10022, US

(21) Appl. No.: 10/116,400

(22) Filed: Apr. 4, 2002

(51) Int. Cl. H04B 10/00; H04B 10/12

(52) U.S. Cl. 398/135

(57) ABSTRACT

A communications system has an optical fiber network and a plurality of wall mounted optical outlets connected to the optical fiber network for receiving light having information coded therein applying same to the optical fiber network and receiving light having information coded therein from the optical fiber network.

### FIELD OF THE INVENTION

The present invention relates to a communications system, and in particular, to a wireless communications system which uses optical fibers and light emitting devices to transmit information.

### BACKGROUND

While radio frequency wireless communication devices are useful outdoors where use of wired data communication links is impractical, there is also a need for wireless communication indoors. However, in many indoor locations other radio frequency devices are present which emit energy that can interfere with the wireless RF signals. As a result, conventional RF wireless systems are unsuitable for use in these locations, suffering from reduced and data transmission rates or and unreliable communication.

Many devices that are used for both wireless and wired communications are equipped with light emitting devices, such as IRDA transceivers. For example, it is known to provide PDA devices, such PALM OS devices, with IRDA transceivers that are used to transmit data between similar devices. Cellular phones with IRDA devices are also known. In addition, bar code scanning devices, such as laser scanners, have light output devices which can be suitable for use in data communications.

It is an object of the present invention to provide a communication system wherein light transmitting devices are used to transmit information via an optical fiber network for reception by a mobile device, such as those noted above, and for receiving the light communications from a device and transmitting it for communications outside the optical fiber network and within the optical fiber network.

Another object of the present invention is to provide a communications system which uses both an optical fiber network and a wired network for communicating with other networks and over the Internet.

### SUMMARY OF THE INVENTION

This and other objects are achieved in accordance with the present invention by a communications system which includes a plurality of wall mounted optical outlets configured to emit and receive light energy. The wall outlets are configured to permit optical communication with a wired network through an intermediate conduit. The conduit between the wall outlets and the wired network is preferably an optical fiber network which can be connected to the wired network using one or more suitable gateways. The gateways are configured to convert information encoded in received optical energy to electrical signals which can be applied to the wired network and for converting data received from the wired network into optical energy which can be output from one or more wall outlets. In an alternative embodiment, the gateways can be connected to an external optical network.

The wall outlets and connecting optical network preferably operate using infrared light and, most preferably, the optical outlet is an IRDA transceiver. However, visible light energy can also be used. The system can be further configured to operate using light at multiple wavelengths to permit different devices to communicate through the same optical outlet without interference or to allow for multiple data communication channels to be supported by a single device.

The present invention can communicate with devices that transmit data using light emitting units, such as PDAs, cellular telephones, computers, appliances, bar code scanners, and the like. The bar code scanners can be “stand-alone” data devices or can be connected to a separate computer terminal.

### BRIEF DESCRIPTION OF THE FIGURES

The foregoing and other features of the present invention will be more readily apparent from the following detailed description and drawings of illustrative embodiments of the invention in which:

FIG. 1 is a high-level schematic of the communications system according to the present invention;

FIG. 2 is an alternative configuration of the communication system of FIG. 1;

FIG. 3 is a block diagram of a unit for communication with the communications system;

FIG. 4 is a diagram of a wall mounted optical outlet for use with the optical fiber network according to the present invention; and

FIG. 5 is an illustration of an alternative communications system according to the present invention.

### DETAILED DESCRIPTION OF THE PREFERRED EMBODIMENTS

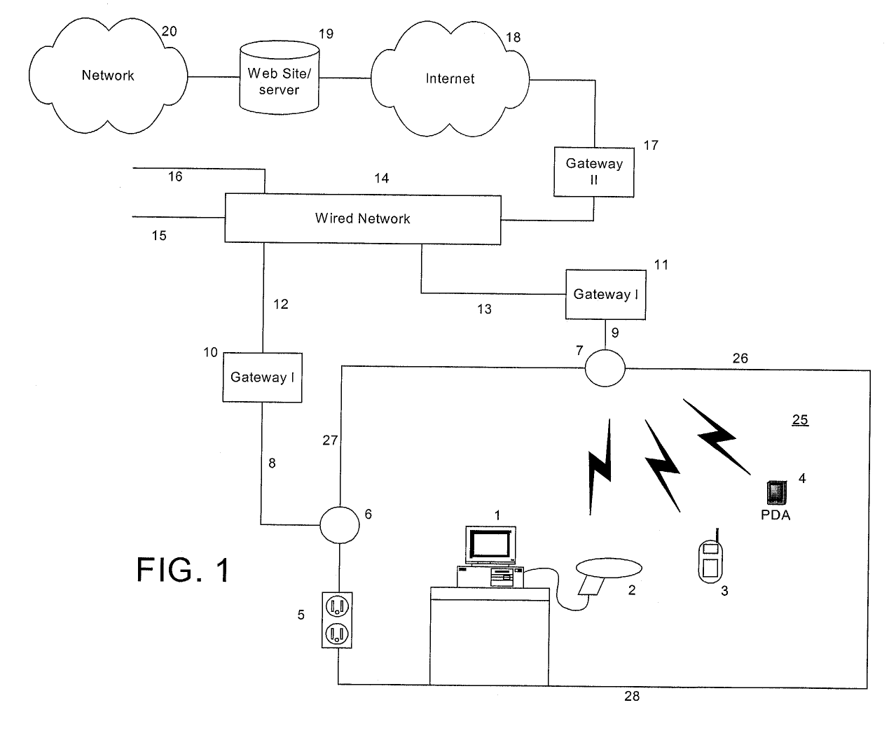

Turning to FIG. 1 there is shown a communications system in accordance with the present invention. A room 25 having floor 28, side wall 27 and ceiling 26 is equipped with a typical electrical outlet 5 connected to an electrical power network. The room 25 further contains mounted optical outlets 6 and 7 which will be described in more detail below.

Various mobile or other data devices which support optical data communications can be located in the room. The optical outlets 6, 7 can be used to provide optical data communications between devices in the room 25 and between a device in the room and remotely located devices. An optical outlet is preferably disposed on the ceiling, such as outlet 7, to enable line-of-sight optical communication between the outlet and a device located in virtually any position in the room. However, an optical outlet can also be located in different positions, such as outlet 6 positioned on the side wall 27.

For example, a cellular telephone 3 or a personal digital assistant (PDA) 4, each having an optical data port, such as an IRDA port, can be present in the room. A computer 1 is also shown and can include peripheral device connected, e.g., to a COM port, USB port, or parallel port of the computer, and configured to support optical communication. One example of such a device is a bar code scanner 2. Various optical communication techniques can be used to communicate with the optical outlet. For example, a modulated laser beam can be used to transmit data using Ethernet protocol (IEEE 802.3 MAC) or an IrDA protocol. The laser light can be visible or infra-red. LEDs and other light generators can also be used to transmit data.

In accordance with one aspect of the invention, each optical outlet 6, 7 is connected to a respective fiber optic cable 8, 9 which, in turn, is connected to an optical gateway 11, 10 (designated as “Gateway I” in FIG. 1). In this embodiment, the gateways 10, 11 convert the optical signals to electrical signals and pass them over wires 13, 12 to a network 14, such as an Ethernet. The network 14 can also communicate via wires 15 and 16 to other networks, such as a fully wired network, or with an optical network via suitable optical fibers, couplers, etc.

In accordance with this system, data is transmitted from the optical output port of a device in the room 27, such as the output of PDA 4 via the IRDA port, and is received at the optical outlet 6, 7 where it is directed into the connected fiber optic cable 8, 9. The data gateway 10, 11 converts the optically encoded data into a suitably formatted signal, such as an electrical data signals or packet, which can then be sent to another device within the network 14 or to a device outside of the network 14, such as a server hosting a website 19 accessed through the Internet 18 (via a separate electrical or optical gateway 17 if needed, and as appropriate).

For example, a user could read a bar code with the PDA (equipped with a suitable scanning module) or by using the bar code scanner 2. The scanned bar code information can then be transmitted to the optical outlet using the IRDA output of the device. The data is received at the outlet, carried over the fiber optic network 8, through the Internet 19, and to the website server 19. When the server 19 receives the bar code data, it retrieves information corresponding to the bar code data, possibly retrieving information from a network 20, and then communicates the information through the Internet 18 to the fiber optic network 8 where the returned data can be transmitted to the PDA 4 by the optical outlet.

Alternatively, the system permits persons within a room to use optical data links to communicate with each other even if there is no clear line of site. Thus, for example, data can be transmitted from PDA 4 to the optical outlet 7, passed to the network through gateway 11 and wire 13, carried by the network 14 and wire 12 to gateway 10, and then through the optical fiber network 9 to wall outlet 6 where it is transmitted to and received by, e.g., a cell phone 3.

It should be noted that the system has been shown in a single room having relatively small dimensions for simplicity. In practice, the optical fiber network can be connected to multiple rooms in a single building, multiple buildings in a complex, or over a wide area network. Alternatively, the network can have intermixed fiber optic connections and wired connections, or it can be a totally fiber optic network.

Each optical outlet can be assigned an address which is stored in the gateway or other system in the network. The address can be used to ensure that light is applied to only to a specific optical outlet (or set of outlets). For example, data packets from the network can be directed to a specific outlet or set of outlets which cover a single room. Similarly, data received from a given optical outlet can be associated with that outlet so that reply data can be properly directed. In a more sophisticated implementation, the devices configured to operate with the optical outlets are assigned a device ID which is included in data transmissions. The ID can then be used to detect when a device has moved out of range of one optical outlet and into range of another. Optical data can then be redirected as appropriate.

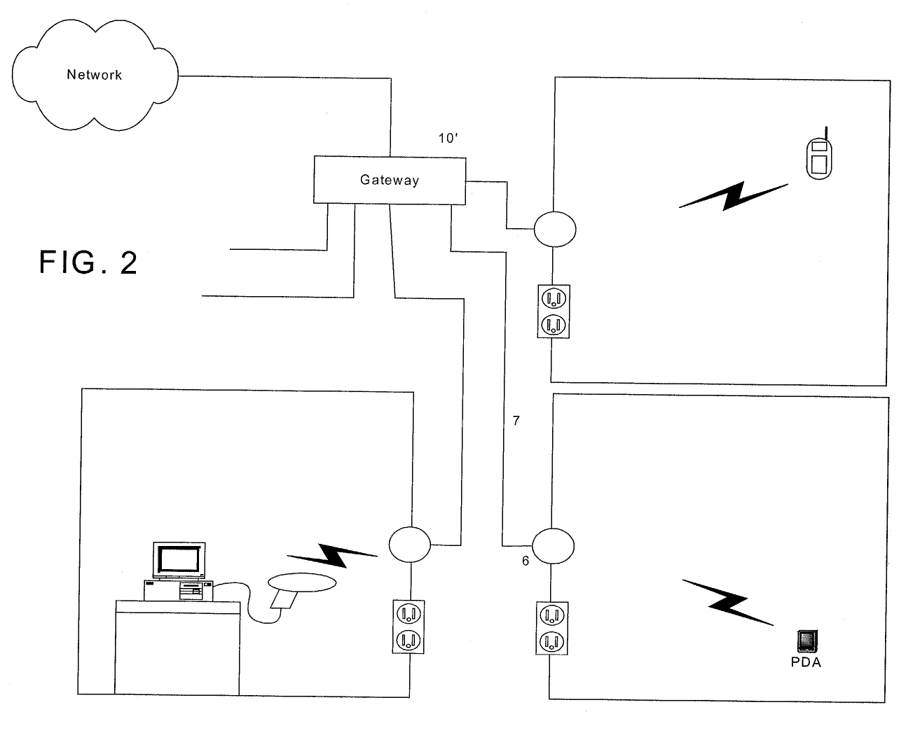

In the embodiment shown in FIG. 1, each optical outlet has its own dedicated gateway. This permits use of relatively simple optical-to-electrical data conversion gateways and also can simplify installation and wiring of optical cables in a building. In an alternative embodiment, shown in FIG. 2, the optical cables from each optical outlet, which outlets can be placed in multiple rooms, are all connected to a common optical gateway 10′. The gateway 10′ can provide access to a data network which can be located within or outside of the building. For example, network access can be provided by a cable modem, DSL, or a PSTN service. Other variations are also possible wherein, for example, a number of gateways are provided, each of which is connected to a plurality of optical fibers and can be, in turn, connected to a central gateway to provide access to another network. In yet another alternative, the gateways (or possibly the outlets themselves) can be connected to a suitable network using wireless data links (not shown).

When the optical gateways are connected to an electrical network, the gateways will typically included an optical detector, such as a photodiode, which is used to convert a received optical pulse train carried on the optical fiber into an electrical signal. The electrical signal is then transmitted over the network link, e.g., in the form of Ethernet data packets. On the transmit side, the gateway receives data packets from the network and uses the data to drive a light source which is connected to the optical fiber so that the light is output in the room, e.g., as a 10 MHz optical data signal that can be detected by optical receivers in the devices in the room.

Advantageously, the use of the optical fiber cables between the optical outlets and the gateways allows for higher data rate transmission relative to electrical data links. For many applications, the distance between the optical outlet and the gateway is short enough to permit use of plastic optical fiber cable that is less expensive than copper cables. In addition, the optical nature of the data signals provides for increased security and less interference from other devices, particularly relative to RF transmissions which can be easily intercepted and which are subject to interference from a wide variety of sources. Moreover, the use of optical data communications, instead of RF communications, allows devices which already contain an optical data interface to be used in a more generalized wireless environment without having to augment those system with RF transmission devices.

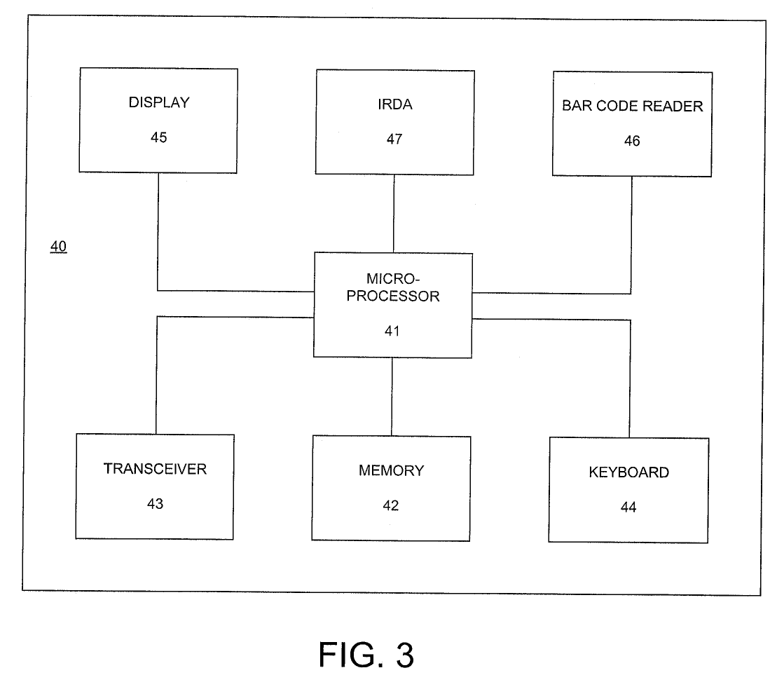

FIG. 3 shows the construction of a PDA or other wireless communication device which is useful with the system in accordance with the present invention. As shown, the device 40 can include a microprocessor 41 connected to a memory 42, such as a RAM, ROM or the like, a wireless transceiver circuit 43 for RF data communications, a keyboard 44 implemented, e.g., using manually actuated keys or a touchscreen, and useful for data input, and a display 45. The microprocessor is also coupled to an IRDA transceiver 47 that can be used to output information via light pulses and receive information from light pulses applied to the IRDA transceiver 47.

A bar code reading module 46 can be used with the microprocessor to read bar codes. The laser diode in a bar code reader 46 can also be configured for use as a light transmitting device under the control of the microprocessor 41. In this instance, the light of the bar code reader can be used as the transmitter and the photodiode or detector in the reader used as a signal receiver, either instead of the IRDA transceiver 47 or in addition to it.

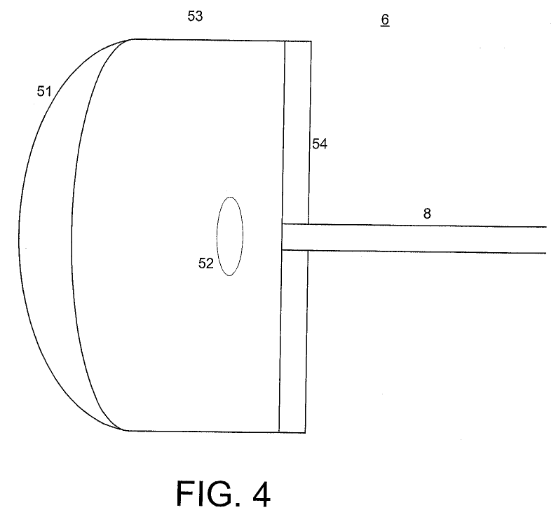

Turning to FIG. 4, there is shown a simplified diagram of the wall mounted optical outlet 6 in accordance with the present invention. As shown, a housing 53 holds a collecting lens 51 which is positioned in front of and directs incident light onto a focusing lens 52. The collecting lens preferably has a diameter of about one inch. The focusing lens 52 is configured to direct light collected by the lens 51 into the fiber optic cable where it is carried to a connected gateway. Similarly, light energy transmitted over the optical cable is spread by the focusing lens and then distributed over a wide area in the room by the collecting lens. A typical fiber optical cable suitable for use with the present invention has a diameter of about 50 micrometers or greater, and preferably on the order of 100 micrometers. Lenses suitable for use in the present optical outlet will be known to those of skill in the art.

In a particular embodiment, the optical outlet comprises at least a portion of an integrating sphere optical condenser. An integrating sphere is essentially a hollow spherical chamber having an inner surface coated with a diffuse reflecting coating. Light enters the sphere through a suitable aperture. The received light energy is reflected multiple times by the coating. This produces a generally uniform field of light in the within the sphere which is passed by the focusing lens, or other optical assembly, into the fiber optic cable and to a detection device. As a result, the signal strength of received light, as sensed by the detector, is generally independent of the angle in which the light enters the optical outlet. This simplifies placement of the optical outlet and reduces issues with respect to the orientation of the outlet relative to a transmitting device and the placement of the focusing lens in the optical outlet.

A holder 54 connected to the housing 53 is provided to hold the optical cable in place. The holder can be integral with the housing 53 such that the optical fiber must be mounted in the holder prior to use. Alternatively, the holder 54 can be wall (or ceiling) mounted with the optical fiber already connected, e.g., as the result of running the optical fibers through the building. The housing 53 can include a mating assembly, such as a snap-on mechanism, to permit the housing 53 to be easily connected those holders of interest and easily replaced when desired.

The gateways 10 and 11 are conventional devices for converting electrical signals to optical signals and vice versa and contain additional computer systems for interfacing to the connected network, such as the Ethernet or the Internet. Gateway 10′, shown in FIG. 2, is similar but contains additional functionality to support multiple optical I/O cables. Gateway 17 in FIG. 1 can be any type of network-to-network interface. Suitable interfaces will be known to those of skill in the art.

In some situations, it may be desired to utilize the optical outlets described above but in an environment where the building is not already “wired” with optical fiber. According to a variation of the present invention, the optical outlets can be connected directly to a network converter or adapter 60 which can then be connected to a standard network interface port. In this embodiment, the optical outlet and optical-to-electrical gateway are essentially combined into a single package. Each optical outlet/network adapter can have a unique ID to permit them to be individually addressable.

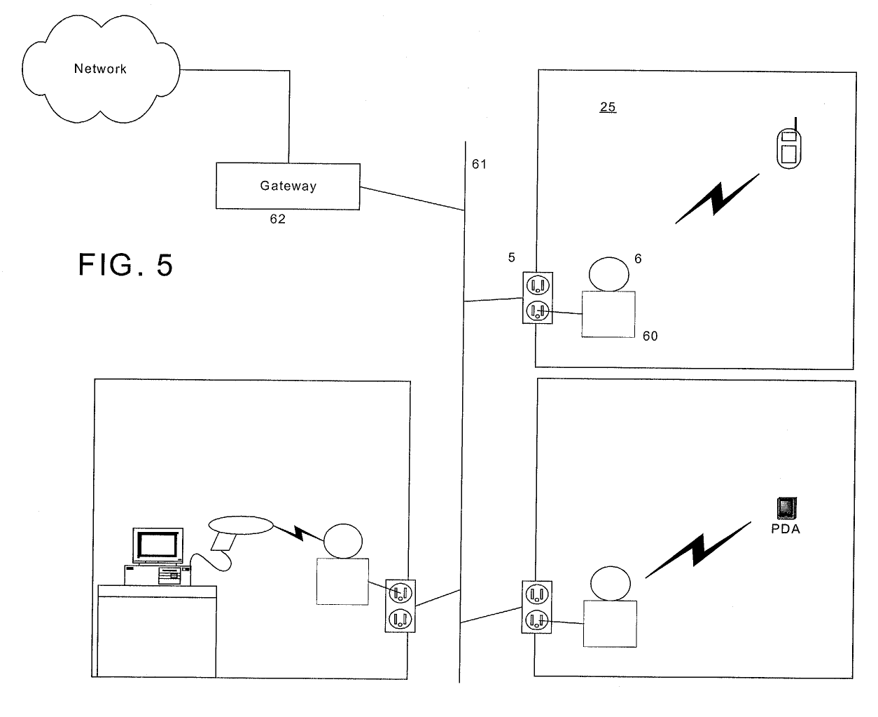

In yet a further alternative of the present invention, shown in FIG. 5, the adapter 60 can be configured to transfer data using a so-called “powerline network” in which signals are injected into the power distribution system 61 of the building. A gateway 62 receives data transmitted over the power system 61 and routes it as appropriate, e.g., to an external network. Gateway 62 can also transmit data on the powerline network 61 for receipt by specified units 60, each of which can have a unique ID. Powerline data networks are known to those of skill in the art and various systems can be used. For example, U.S. Pat. No. 6,243,413, the contents of which is incorporated by reference, is entitled “Modular home-networking communication system and method using disparate communication channels” and discloses a powerline communication system which supports data rates of 1 Mbps over a typical powerline channel in a home environment.

Preferably, in both of the combined optical outlet/network-adapter systems, the combination is packaged in a small and compact assembly which can be connected directly to the network or power outlet so that it can be quickly and easily installed and operated.

Although the present invention has been discussed largely with respect to using the gateways to access a wired network, the invention is also suitable for use in coupling to an all optical network, such as a fiber optic Ethernet network transmitting data at wavelengths of, e.g., 850 nm or 1300 nm. Appropriate gateways for coupling the optical outlets to an optical network will be known to those of skill in the art. In addition, other components which may be useful in implementing the present invention, such as multiplexers, couplers, optical amplifiers, etc., will also be known to those of skill in the art.

It is understood that the embodiments described herein are merely illustrative and are not intended to limit the scope of the invention. It is realized that various changes, alterations, rearrangements and modifications can be made by those of skill in the art without departing from the spirit and scope of the invention.

What is claimed is:

1. A communications system, comprising:
an optical fiber network; and
a plurality of optical outlets connected to the optical fiber network for (a) receiving light having information coded therein and applying same to the optical fiber network and (b) receiving light having information coded therein from the optical fiber network.

2. The system according to claim 1, further comprising a gateway connected to the optical network for converting the information encoded in the light to signals to a form suitable for applying to a second network.

3. The system according to claim 2, wherein the second network is a wired network and the gateway converts information in the light to electrical signals.

4. The system according to claim 1, wherein the at least one optical outlet receives infrared light.

5. The system according to claim 4, wherein the at least one optical outlet is an IrDA receiver.

6. The system according to claim 1, further comprising units having transceivers for transmitting light having information encoded therein to one optical outlet and for receiving light having encoded information therein from one optical outlet.

7. The system according to claim 6, wherein the units comprise at least one selected from the group comprising PDAs, cellular telephones, computers, and home appliances.

8. The system according to claim 6, wherein the units comprise computer terminals having bar code readers.

9. The system according to claim 8, further comprising a gateway connected to the optical network for converting the information encoded in the light to electrical signals for applying to the Internet.

10. The system according to claim 9, wherein the terminals have a processor therein for reading the bar codes and connecting to a website corresponding thereto over the optical network.
